(19) United States
(12) Patent Application Publication
(10) Pub. No.: US 2026/0098175 A1
(43) Pub. Date: Apr. 9, 2026

(54) SOLVENT-BASED SEALANT COMPOSITION

(71) Applicant: H.B. Fuller Company, St. Paul, MN (US)

(72) Inventors: Molly E. Magnuson, Columbia Heights, MN (US); Christian I. Moreno, South Bend, IN (US)

(21) Appl. No.: 19/347,940

(22) Filed: Oct. 2, 2025

Related U.S. Application Data
(60) Provisional application No. 63/703,002, filed on Oct. 3, 2024.

(51) Int. Cl. C09D 123/16; C09D 7/20; C09D 7/61; C09D 7/63; C09D 7/65; C09D 171/00

(52) U.S. Cl. CPC C09D 123/16; C09D 7/20; C09D 7/61; C09D 7/63; C09D 7/65; C09D 171/00

(57) ABSTRACT

The invention is directed to a solvent-based sealant composition having improved skinning properties.

This application claims the benefit of U.S. Provisional Application No. 63/703,002, filed Oct. 3, 2024, and incorporated herein.

### BACKGROUND

Recreational vehicles and other types of structures (e.g., utility vehicles, trailers, buses, walk-in vans, box trucks, rail cars, ambulances, boats, sheds, etc.) are exposed to high speeds and various forces as they are used to transport people and goods. Such structures can further be exposed to a variety of weather conditions during their normal use, e.g., extreme temperatures, snow and rain. It is critical that the exterior of the structure be watertight to prevent water from getting into the structure and causing damage to it.

To ensure that the exterior of a structure is watertight, sealants are needed not only on the roof to wall joints but also along wall to wall joints, around corners, around the flange of inserted items (e.g., windows, doors, etc.), around access points to various functionality, e.g., water hook ups, electricity hook ups, etc. and in any other place where gaps are formed during construction.

Solvent-based sealants have advantages in that they can be low in cost and further can have self-leveling properties which are desirable when such sealants are used for example on the roof of a recreational vehicle. However, solvent-based sealants can be slow to gain their final properties when preferred solvents are used in combination with fillers as it takes time for the solvent to evaporate.

There is a need for a solvent-based sealant that can gain final properties quickly as witnessed by forming a skin within minutes while maintaining the desirable properties of a solvent-based sealant including low cost and self-leveling.

### SUMMARY

### Detailed Description

In one aspect, the invention features a sealant composition including from 3% by weight to 25% by weight of a thermoplastic elastomer, from 1% by weight to 10% by weight of a silane modified polymer, from 20% by weight to 50% by weight of a filler, and from 20% by weight to 70% by of a solvent.

In one embodiment, the sealant composition has a moisture content of no more than 1.0% by weight, or even no more than 0.5% by weight as tested by Karl Fischer titration according to ASTM D6304. In another embodiment, the sealant composition includes a moisture scavenger.

In one embodiment, the sealant composition is free of hazardous air pollutants as defined by the US Environmental Protection Agency. In a different embodiment, the thermoplastic elastomer is not silane modified. In another embodiment, the thermoplastic elastomer is selected from the group consisting of butyl rubber, polyisobutylene rubber, EPDM (ethylene-propylene-diene) rubber, hydrogenated styrenic block copolymer, functionalized versions thereof and combinations thereof. In one embodiment, the thermoplastic elastomer is selected from the group consisting of butyl rubber, polychloroprene, polyisobutylene rubber, polybutene, ethylene vinyl acetate, ethylene alkyl acrylate, EPDM (ethylene-propylene-diene) rubber, block copolymer elastomers, styrenic block copolymer elastomers, functionalized versions thereof and combinations thereof.

In a different embodiment, the silane modified polymer is selected from the group consisting of polyether, polyester, polyether/polyester block copolymers, polyurethane, polyacrylic, polyisobutylene, polyisoprene, polybutadiene and combinations thereof. In another embodiment, the silane modified polymer is selected from the group consisting of polyethers, polyesters, polyether polyester copolymers, polyurethanes, and combinations thereof. In one embodiment, the silane modified polymer is silane terminated. In another embodiment, the silane modified polymer is a modified with a tri-functional alpha silane.

In one embodiment, the sealant composition includes a filler selected from the group consisting of calcium carbonate, clay, talc or a combination thereof. In a different embodiment, the solvent is selected from the group consisting of naphtha, mineral spirits, toluene, xylene, ethylbenzene, cumene, heptane, hexane, cyclohexane, pentane, ethyl acetate, methyl acetate, propyl acetate, acetone, parachlorobenzotrifluoride (PCBTF), methyl ethyl ketone (MEK), methyl isobutyl ketone, alcohols (e.g. isopropanol), propylene carbonate, dimethyl carbonate, tetrahydrofuran (THF) and combinations thereof. In another embodiment, the solvent is selected from the group consisting of naphtha, heptane, mineral spirits and a combination thereof.

In one embodiment, the sealant composition includes a moisture scavenger selected from the group consisting of p-toluenesulfonyl isocyanate (PTSI), vinyltrimethoxysilane (VTMO), vinyl triethoxysilane (VTEO), vinyltris(2-methoxyethoxy)silane (VTMOEO), molecular sieves, and combinations thereof.

In a different embodiment, the sealant composition further includes a tackifying agent. In another embodiment, the tackifying agent is a hydrocarbon resin selected from the group consisting of aliphatic, cycloaliphatic, aromatic, aliphatic-aromatic, aromatic modified alicyclic, and alicyclic hydrocarbon resins, modified versions and hydrogenated derivatives thereof, and combinations thereof.

In one embodiment, the sealant composition can have a room temperature viscosity (RV7, 2 rpm) of from 100,000 cP to 600,000 cP, or even from 150,000 cP to 500,000 cP. In another embodiment, the sealant composition forms a skin in less than 15 minutes.

In a different aspect, the invention features a sealant composition including from 3% by weight to 15% by weight of a thermoplastic elastomer selected from the group consisting of butyl rubber, polyisobutylene rubber, EPDM (ethylene-propylene-diene) rubber, hydrogenated styrenic block copolymers, functionalized versions thereof and combinations thereof, from 1% by weight to 7% by weight of a silane modified polymer, from 25% by weight to 45% by weight of a filler, from 25% by weight to 55% by weight of a solvent, and a moisture scavenger.

In one embodiment, the invention features a structure selected from the group consisting of a recreational vehicle, utility vehicle, trailer, bus, walk-in van, box truck, rail car, ambulance boat, and shed comprising the sealant composition. In another embodiment, the sealant composition is used on the roof.

The invention features a solvent-based sealant that can gain final properties quickly as witnessed by forming a skin within minutes while maintaining the desirable properties of a solvent-based sealant including low cost and self-leveling.

### Sealant Composition

The invention features a one component, solvent-based sealant composition.

The sealant composition can include from 3% by weight to 25% by weight of a thermoplastic elastomer, from 1% by weight to 10% by weight of a silane modified polymer, from 20% by weight to 50% by weight of a filler, and from 20% by weight to 70% by weight of a solvent.

The sealant composition can include from 3% by weight to 25% by weight of a thermoplastic elastomer, from 1% by weight to 7% by weight of a silane modified polymer that is liquid at room temperature, from 20% by weight to 50% by weight of a filler, and from 20% by weight to 70% by weight of a solvent.

The sealant composition can include from 3% by weight to 15% by weight of a thermoplastic elastomer selected from the group consisting of butyl rubber, polyisobutylene rubber, EPDM (ethylene-propylene-diene) rubber, hydrogenated styrenic block copolymers, functionalized versions thereof and combinations thereof, from 1% by weight to 7% by weight of a silane modified polymer,

from 25% by weight to 45% by weight of a filler, from 25% by weight to 55% by weight of a solvent, and a moisture scavenger.

The sealant composition can also include from 3% by weight to 15% by weight of a thermoplastic elastomer selected from the group consisting of butyl rubber, EPDM (ethylene-propylene-diene) rubber and combinations thereof, from 1% by weight to 5% by weight of a silane modified polymer, from 25% by weight to 45% by weight of a filler, from 25% by weight to 55% by weight of a solvent selected from the group consisting of heptane, naphtha, mineral spirits and combinations thereof, and a moisture scavenger.

The thermoplastic elastomer, the silane modified polymer, the filler, the tackifying agent, and the solvent can make up at least 80% by weight, at least 85% by weight, at least 90% by weight, from 80% by weight to 100% by weight, from 85% by weight to 100% by weight or even from 90% by weight to 100% by weight of the sealant composition.

The sealant composition can be free of hazardous air pollutants (HAPs) as defined by the EPA (United States Environmental Protection Agency). Hazardous air pollutants are those known to cause cancer and other serious health impacts. The full list of HAPs can be found on the EPA (United States Environmental Protection Agency) website.

The sealant composition has a solids content of from 25% by weight, 30% by weight, 35% by weight to 45% by weight, 47% by weight, 50% by weight, 52% by weight, 55% by weight, 60% by weight, 65% by weight, 70% by weight or any two values therebetween.

The sealant composition can have a viscosity (RV 7, 16 g, 2 rpm) of from 50,000 cP, 75,000 cP, 100,000 cP, 125,000 cP, 150,000 cP, 200,000 cP, 225,000 cP, 250,000 cP, 275,000 cP, 300,000 cP to 450,000 cP, 500,000 cP, 525,000 cP, 550,000 cP, 575,000 cP, 600,000 cP, 700,000 cP, 800,000 cP, 900,000 cP, 1,000,000 cP, 2,000,000 cP, 3,000,000 cP or any two values there between. The sealant composition can be self-leveling when applied at room temperature, while not being so low in viscosity so as drip and run excessively in use. For other applications, the sealant composition does not have to be self-leveling.

The sealant composition can have a limited moisture content to enable shelf stability. The limited moisture content can be achieved in any number of ways including drying the raw materials prior to forming the adhesive, utilizing a moisture scavenger, or any other way of limiting moisture content. The sealant composition can have a moisture content of no greater than 2% by weight, no greater than 1% by weight, no greater than 0.5% by weight, no greater than 0.3%, from 0% by weight to 2% by weight, or even from 0% by weight to 1% by weight as tested by Karl Fischer titration according to ASTM D6304

The sealant composition is able to form a “skin” or non-tacky layer on the surface of the sealant in less than 20 minutes, less than 15 minutes, less than 10 minutes, or even less than 8 minutes as tested by the skin formation test method. This fast skin formation is important as it prevents foreign debris from becoming attached to the sealant and enables the manufacturing process to go faster, i.e., it is not necessary to wait as long for the sealant composition to form a skin.

### Thermoplastic Elastomer

The sealant composition includes one or more thermoplastic elastomers to help provide strength and flexibility to the sealant composition.

Useful thermoplastic elastomers include butyl rubber, polychloroprene, polyisobutylene rubber, polybutene, ethylene vinyl acetate, ethylene alkyl acrylate (e.g., ethylene methyl acrylate, ethylene methyl methacrylate, ethylene n-butyl acrylate, ethylene ethyl acrylate, etc.), EPDM (ethylene-propylene-diene) rubber, block copolymer elastomers, styrenic block copolymer elastomers, functionalized versions thereof and combinations thereof.

The thermoplastic elastomer can have an average molecular weight of at least 100,000 g/mol, from 100,000 g/mol to 600,000 g/mol, even from 150,000 g/mol to 400,000 g/mol. The thermoplastic elastomer can have an average Mooney viscosity of at least 20, at least 25, at least 30, from 15 to 75, or even from 20 to 55 as tested according to ASTM D 1646 and as reported by the supplier. When more than one thermoplastic elastomer is present, the values for weight average molecular weight and Mooney viscosity refer to the weight average of all thermoplastic elastomers present.

The thermoplastic elastomer can be selected from the group consisting of butyl rubber, polyisobutylene rubber, EPDM (ethylene-propylene-diene) rubber, functionalized versions thereof and combinations thereof. In one embodiment, the thermoplastic elastomer is not silane modified.

Useful butyl rubbers are commercially available in a variety of grades from ExxonMobil Chemical Corporation (Houston, TX) including, e.g., 065, 066, 165, 268, 365, and 395 butyl rubbers, from Lanxess Deutschland GmbH (Germany) including e.g., RB100, RB101, RB301, and RB 402 butyl rubbers, and from United Chemical Products (Russia) including BK-1657N butyl rubber.

Useful polyisobutylene rubbers are commercially available under a variety of trade designations including, e.g., under the OPPANOL series of trade designations from BASF Corporation (Florham, N.J.) including, e.g., OPPANOL B100 having a Mw of 1550 kg/mol and OPPANOL B150 having a Mw of 3050 kg/mol.

Useful EPDM rubbers are commercially available under a variety of trade designations including, e.g., under the VISTALON series of trade designations from ExxonMobil including VISTALON 6602, under the KELTON series of trade designations from Lanxess Deutschland GmbH (Germany) including KELTON 2450 EPDM rubber and under the SABIC series of trade designations from Saudi Basic Industries Corporation (SABIC) (Saudi Arabia) including SABIC 245.

Useful styrenic block copolymers have at least one A block that includes styrene and at least one B block that includes, e.g., elastomeric conjugated dienes (e.g., hydrogenated and unhydrogenated conjugated dienes), sesquiterpenes (e.g., hydrogenated and nonhydrogenated sesquiterpenes), and combinations thereof. The A blocks and the B blocks bind to one another in any manner of binding such that the resulting copolymer exhibits a variety of structures including, e.g., random, straight-chained, branched, radial, star, comb, tapered, and combinations thereof. The block copolymer can exhibit any form including, e.g., linear A-B block, linear A-B-A block, linear A-(B-A)n-B multi-block, and radial (A-B)n-Y block where Y is a multivalent compound and n is an integer of at least 3, tetrablock copolymer, e.g., A-B-A-B, and pentablock copolymers having a structure of A-B-A-B-A. The sealant composition can include blends of at least two different block copolymers.

Suitable styrene A blocks include, e.g., styrene, alpha-methylstyrene, o-methylstyrene, m-methylstyrene, p-methylstyrene, p-tert-butylstyrene, 2,4-dimethylstyrene, 2,4,6-trimethylstyrene, and combinations thereof.

Suitable block elastomeric conjugated diene B blocks include, e.g., butadiene (e.g., polybutadiene), isoprene (e.g., polyisoprene), 2,3-dimethyl-1,3-butadiene, 1,3-pentadiene, 1,3-hexadiene, and combinations thereof, and hydrogenated versions thereof including, e.g., ethylene, propylene, butylene and combinations thereof.

Useful styrenic block copolymers can include styrene diblock copolymers (e.g., styrene-butadiene (SB) and styrene-isoprene block (SI)) styrene-butadiene-styrene (SBS), styrene-isoprene-styrene (SIS), styrene-ethylene-butylene-styrene (SEBS), styrene-ethylene-propylene-styrene (SEPS), styrene-isobutylene-styrene, and combinations thereof.

Useful styrenic block copolymers can include styrene-ethylene-butylene-styrene (SEBS), styrene-ethylene-propylene-styrene (SEPS), styrene-isobutylene-styrene, and combinations thereof.

Useful styrenic block copolymer elastomers are commercially available under the KRATON G series of trade designations Kraton Corporation, from (Houston, Tex.) including, e.g., KRATON G 1652 SEBS, G 1657 SEBS, G 1726 SEBS, and G 1901 SEBS and HYBRAR H7125 and H7311 hydrogenated SIS block copolymers from Kuraray America Inc. (Houston, Tex.).

The sealant composition includes from 3% by weight, 3.5% by weight, 4% by weight, 5% by weight to 6% by weight, 7% by weight, 9% by weight, 10% by weight, 12% by weight, 14% by weight, 15% by weight, 18% by weight, 20% by weight, 22% by weight, 25% by weight, or any two values therebetween of thermoplastic elastomer.

### Silane Modified Polymer

The sealant composition includes one or more silane modified polymers. The silane modified polymer includes silyl groups on its polymer chains. The silyl group can be grafted on to the polymer chain, or the polymer chain can be terminated with the silyl group. Although: the silyl groups can be present at any point within the polymer structure, it is preferred that the silyl groups are present at the end of the polymer chains i.e. the polymer chains are terminated with the silyl groups.

The silane modified polymer enables the solvent-based composition to form a skin in less time as compared to the solvent-based composition without the silane modified polymer; this is due to crosslinking of the silyl groups.

The silane modified polymer can be selected from the group consisting of polyether, polyester, polyether/polyester block copolymers, polyurethane, polycarbonate, polyacrylic, polyisobutylene, polyisoprene, polybutadiene and combinations thereof.

The silane modified polymer can be a liquid at room temperature (23-27° C.). By liquid what is meant is that the polymer flows at room temperature.

In one embodiment, the silane modified polymer is selected from the group consisting of polyethers, polyurethanes, polyisobutylene, polyisoprene, polybutadiene, and combinations thereof.

Useful silane modified polymers can contain alkoxy silyl groups. Silane modified polymers can differ in their organic structure, specifically in the manner the silyl groups are linked to the polymer backbone and the distance between the silyl groups and the backbone.

The silane modified polymer can include an alpha silane or a gamma silane. In an alpha silane, the alkoxy silyl group is bonded to an electronegative free electron pair containing heteroatom via a methylene linking group, in a gamma silane the bond is via a propylene linking group. In one embodiment, alpha silanes are preferred as they react more quickly.

The electronegative free electron pair containing heteroatom can include any number of chemical groups including, e.g., amino, epoxy, glycidoxy, mercapto, sulfide, urethane, isocyanate, etc.

The alpha or gamma silane can include one or more silyl group i.e. it can be mono functional, di functional or tri functional. In one embodiment, a modification with a tri functional alpha silane is preferred.

The silane modified polymer can be modified with a compound selected from the group consisting of methoxy (diethyl) silyl methyl carbamate, dimethoxy (ethyl) silyl methyl carbamate, methoxy (dimethyl) silyl methyl carbamate, dimethoxy(methyl) silyl methyl carbamate, trimethoxy silyl methyl carbamate, trimethoxy(methyl) silyl propyl carbamate, methoxy (dimethyl) silyl propyl carbamate, dimethoxy(methyl) silyl propyl carbamate, trimethoxy silyl propyl carbamate and triethoxy silyl propyl ethyl carbamate.

Useful silane modified polymers includes silane functional polyether polymers available under the GENIOSIL series of trade designations from Wacker Chemie AG (Germany) including GENIOSIL STP E35, GENIOSIL XM 25, GENIOSIL XM 20, GENIOSIL E15, GENIOSIL E30 and GENIOSIL E10.

Useful commercially available silane modified polymers also include, e.g., liquid silane functional polyether polymers available under the trade designations KANEKA SAX 725, KANEKA SAX 720 and KANEKA S303 H and silane modified polyacrylic polymers available under the trade designations KANEKA MAX 951 and KANEKA MAX 923, all from Kaneka Texas Corporation (Houston, TX), silane modified polybutadiene polymers available under the EPION series of trade designations from Kaneka Texas Corporation (Houston, TX) and silane modified polymers available under the SPUR+ series of trade designations from Momentive Performance Materials (NY).

The sealant composition can include from 1.0% by weight, 1.5% by weight, 1.8% by weight to 2.2% by weight, 2.3% by weight, 2.4% by weight, 2.5% by weight, 2.7% by weight, 3% by weight, 3.2% by weight, 3.5% by weight, 4% by weight, 4.5% by weight, 5% by weight, 6% by weight, 7% by weight, 8% by weight 9% by weight, 10% by weight or any two values therebetween of the silane modified polymer.

### Solvent

The sealant composition includes one or more solvent as a carrier to dissolve and/or dilute the components and enable application. After application, the solvent evaporates. The solvent can be selected from the group consisting of naphtha, mineral spirits, toluene, xylene, ethylbenzene, cumene, heptane, hexane, cyclohexane, pentane, ethyl acetate, methyl acetate, propyl acetate, acetone, parachlorobenzotrifluoride (PCBTF), methyl ethyl ketone (MEK), methyl isobutyl ketone, alcohols (e.g. isopropanol), propylene carbonate, dimethyl carbonate, tetrahydrofuran (THF) and combinations thereof.

The solvent can be free of solvents categorized as hazardous air pollutants (HAPs) as defined by the EPA (United States Environmental Protection Agency). The solvent can be selected from the group consisting of heptane, naphtha, mineral spirits and combinations thereof.

The sealant composition includes from 20% by weight, 25% by weight, 30% by weight, 35% by weight, 40% by weight to 50% by weight, 55% by weight, 60% by weight, 65% by weight, 70% by weight, or any two values therebetween of solvent.

### Filler

The sealant composition includes one or more fillers. The filler can be useful to give the sealant more body and lower cost. Useful fillers include, e.g., clay, talc, fumed silica, precipitated silica, aluminum silicates, nano powders, carbon black, titanium dioxide, iron oxide, calcium carbonate, precipitated calcium carbonate, functional versions thereof, treated versions thereof and combinations thereof.

The sealant composition preferably includes a blend of fillers (two or more fillers) to help balance the properties of the sealant composition.

The filler can have a median diameter particle size of from 3 μm, 4 μm, 5 μm to 8 μm, 9 μm, 10 μm, 12 μm as reported by the supplier.

Useful fillers are commercially available under a variety of trade designations including under the OMYACARB trade designation available from Shiraishi Omya GmbH (Japan) including OMYACARB 6 PT and OMYACARB IT-SJ, under the NEOLIGHT trade designation available from Neoflex Inc. (Arizona, USA) including NEOLIGHT SP and under the GARAMITE trade designation available from Garamite Materials Inc. (Nevada, USA) including GARAMITE 1958.

The sealant composition can include from 20% by weight, 22% by weight, 25% by weight to 32% by weight, 35% by weight, 37% by weight, 40% by weight, 42% by weight, 45% by weight, 50% by weight or any two values therebetween of filler.

### Moisture Scavenger

Since upon exposure to moisture, groups of the silane modified polymer undergo hydrolysis and crosslinking, it is necessary to make sure the moisture content of the sealant composition is limited. This can be accomplished by using one or more moisture scavengers.

The type of moisture scavenger is not particularly limited and can be selected from the group consisting of p-toluenesulfonyl isocyanate (PTSI), vinyltrimethoxysilane (VTMO), vinyl triethoxysilane (VTEO), vinyltris(2-methoxyethoxy)silane (VTMOEO), molecular sieves, and combinations thereof.

Useful moisture scavengers are commercially available under a variety of trade designations including under the STABAXOL trade designation available from Clariant International Ltd. (Switzerland) e.g., STABAXOL P200, STABAXOL 1LF and STABAXOL MTC, under the ZOLDINE trade designation available from Zschimmer & Schwarz Chemie GmbH (Germany) e.g. ZOLDINE MS-PLUS and ADDITIVE OF available from BASF SE (Germany).

The sealant composition can include from 0.5% by weight, 1% by weight, 1.5% by weight, 1.75% by weight, 2% by weight, 2.5% by weight, 2.75% by weight to 3.5% by weight, 3.75% by weight, 4% by weight, 4.5% by weight, 5% by weight or any two values therebetween of moisture scavenger. \

### Tackifying Agent

The sealant composition can optionally include a tackifying agent.

Useful tackifying agents include, e.g., aromatic, aliphatic, and cycloaliphatic hydrocarbon resins, mixed aromatic and aliphatic modified resins, aromatic modified hydrocarbon resins, and hydrogenated versions thereof; terpenes, modified terpenes, and hydrogenated versions thereof; rosin esters (e.g., glycerol rosin ester, pentaerythritol rosin ester, and hydrogenated versions thereof); and combinations thereof. Useful aromatic resins include, e.g., aromatic modified hydrocarbon resins, alpha-methyl styrene resin, coumorone-indene resins, and styrenated terpene resin, phenolic resins (e.g. novalax, resoles, etc.), polyterpenes, and combinations thereof.

The tackifying agent can be a hydrocarbon resin selected from the group consisting of aliphatic, cycloaliphatic, aromatic, aliphatic-aromatic, aromatic modified alicyclic, and alicyclic hydrocarbon resins, modified versions and hydrogenated derivatives thereof, and combinations thereof.

The tackifying agent can have a softening point of from 80° C., 85° C., 90° C. to 100° C., 105° C., 110° C., 115° C., 130° C., 140° C., 150° C., 165° C. or any two values therebetween.

Suitable tackifying agents are commercially available under a variety of trade designations including, e.g., partially hydrogenated aromatic modified petroleum hydrocarbon resins available under the ESCOREZ series of trade designations from ExxonMobil including, e.g., ESCOREZ 5615 ESCOREZ 5600 and ESCOREZ 5637, partially hydrogenated cycloaliphatic petroleum hydrocarbon resins commercially available under the EASTOTAC series of trade designations from Eastman Chemical Co. (Kingsport, Tenn.) including, e.g., EASTOTAC H-100, H-115, H-130 and H-142, partially hydrogenated cycloaliphatic petroleum hydrocarbon resins and aliphatic-aromatic petroleum hydrocarbon resins available under the WINGTACK EXTRA and WINGTACK 95 trade designation from Cray Valley and HCR-1095 from Global Chemsource.

The sealant composition can include from 2% by weight, 3% by weight, 4% by weight to 7% by weight, 8% by weight, 9% by weight, 10% by weight, 11% by weight, 12% by weight, 13% by weight, 15% by weight, 18% by weight, or any two values therebetween of tackifying agent.

### Additional Components

The sealant composition can include additional components selected from the group consisting of silane adhesion promoters, pigments, dyes, plasticizers (e.g. hydrocarbon oils, polyols (e.g. polyester diols, polyether diols, etc.), phthalate based, phthalate free), etc.

The sealant composition can optionally include a silane adhesion promoter. Useful silane adhesion promoters are available under the GENIOSIL series of trade designations from Wacker Chemie AG (Germany) and include GENIOSIL XL 10, GENIOSIL XL 65 and GENIOSIL GF 96.

### Additives

The sealant composition can include additives (materials often present in small amounts) such as e.g. antioxidants, UV stabilizers, rheology modifiers, specialty fillers (e.g. glass bubbles), etc.

The sealant composition includes a total amount of additives of less than 8% by weight, or even less than 5% by weight. The sealant composition can include from 0.5% by weight, 1% by weight to 3% by weight, 5% by weight, 8% by weight or any two values therebetween of additives.

### Uses

The invention features a method of using the sealant composition to seal various seams on the exterior of a structure. The structure can be selected from the group consisting of a recreational vehicle, utility vehicle, trailer, bus, walk-in van, box truck, rail car, ambulance boat, and shed.

The sealant composition can be used to seal any part of the structure but is particularly useful in sealing the seams of a roof. The sealant composition can also be used as an adhesive composition when a faster set is desired such as for bonding metals and plastics e.g. sidewall bonding.

### EXAMPLES

### Test Procedures

Test procedures used in the examples and throughout the specification, unless stated otherwise, include the following.

The sealant composition examples were made by blending a commercially available solvent-based product with a commercially available silane modified polymer product and then adding additional solvent as needed. All three were mixed for 30 seconds at 1200 RPM, the sides scraped down and then mixed another 30 seconds at 1200 RPM.

### Self-Leveling

Two milliliters of sealant composition was dispensed between two parallel lines around ½″ apart. The sealant composition was evaluated based on how far beyond the lines it flowed. If it flowed beyond the parallel lines in 5 minutes, the composition is given a “yes” rating, if not the composition is given a “no” rating.

### Skin Formation

The sealant composition was dispensed in a long bead. The timer was then started. Initially, the bead was lightly tapped on the surface every minute with a gloved hand, as the sealant composition became closer to skinning, it was checked every 15 seconds until the skin remained intact, and no transfer was made to glove, this time was noted. A new spot on the bead was used for every tap.

### Viscosity

Sixteen grams was placed into a Brookfield viscometer test tube. The viscosity was measured at room temperature (around 23° C.) using the spindle and conditions noted. The measurement was made after 2 minutes of rotation.

### Shelf Stability Test Method at Room Temperature (Around 23° C.)

Approximately 1 gallon of sealant composition was made and stored it in several pintsized containers for different time points and the viscosity tested using spindle RV7 at 2 rpm at 2 min.

Sag was tested according to ASTM D2202.

TABLE 1
Examples

| RM Name | RM Type | 1 | 2 | 3 | 4 | 5 | 6 | 7 | 8 | 9 | 10 |
|---|---|---|---|---|---|---|---|---|---|---|---|
| BUTYL RB402, | Butyl | 2.21 | 1.91 | 1.65 | 1.44 | 1.25 | 1.65 | 2.19 | 2.03 | 2.05 | 2.93 |
| RB301 | Rubber | | | | | | | | | | |
| SABIC 245 | EPDM | 6.64 | 5.73 | 4.96 | 4.31 | 3.76 | 4.95 | 6.59 | 6.09 | 6.11 | 8.78 |
| GENIOSIL | Silane | 1.26 | 2.30 | 3.17 | 3.90 | 4.54 | 1.98 | 2.66 | 1.88 | 1.70 | 1.79 |
| grades | modified | | | | | | | | | | |
| | polyether | | | | | | | | | | |
| | polymers | | | | | | | | | | |
| OMYACARB | Calcium | 32.59 | 32.42 | 32.27 | 32.16 | 32.05 | 27.99 | 37.33 | 32.46 | 35.88 | 33.21 |
| 1T-SJ, | Carbonate | | | | | | | | | | |
| OMYACARB | | | | | | | | | | | |
| 6 PT, | | | | | | | | | | | |
| NEOLIGHT | | | | | | | | | | | |
| SP | | | | | | | | | | | |
| TIO2 | Pigment | 3.17 | 2.74 | 2.37 | 2.06 | 1.80 | 2.36 | 3.15 | 2.91 | 2.92 | 3.52 |
| GARAMITE | Powdered | 2.17 | 1.87 | 1.62 | 1.41 | 1.23 | 1.62 | 2.15 | 1.99 | 1.97 | 2.41 |
| 1958 | Silicate | | | | | | | | | | |
| WINGTACK | Tackifying | 9.62 | 8.30 | 7.19 | 6.25 | 5.45 | 7.17 | 9.55 | 8.82 | 8.83 | 6.97 |
| 95 | agent | | | | | | | | | | |
| GENIOSIL | Silane | 0.18 | 0.33 | 0.46 | 0.56 | 0.65 | 0.29 | 0.38 | 0.27 | | |
| XL 10, | adhesion | | | | | | | | | | |
| XL 65, | promoter | | | | | | | | | | |
| GF 96 | | | | | | | | | | | |
| VORANOL | Polyether | 1.42 | 2.59 | 3.56 | 4.39 | 5.11 | 2.23 | 2.99 | 2.12 | | |
| 2120 | (propylene | | | | | | | | | | |
| | glycol | | | | | | | | | | |
| | diol) | | | | | | | | | | |
| (PTSI) p- | Moisture | | | | | | | | | 3.39 | 3.28 |
| Toluenesulfonyl | Scavenger | | | | | | | | | | |
| Isocyanate | | | | | | | | | | | |
| | Additives | 0.62 | 1.07 | 1.42 | 1.74 | 2.01 | 0.91 | 1.22 | 0.90 | 0.09 | 0.11 |
| 50/50 blend of | Solvent | 40.12 | 40.74 | 41.33 | 41.81 | 42.15 | 48.85 | 31.79 | 40.53 | 37.06 | 37 |
| NAPHTHA H.T. | | | | | | | | | | | |
| and Heptane | | | | | | | | | | | |
| Self-leveling | | Yes | Yes | Yes | Yes | Yes | Yes | Yes | Yes | Yes | Yes |
| Skin Formation | | <10 | <6 | 4 | 7 | <11 | 10 | <10 | Not | 7 | 7 |
| Time (minutes) | | | | | | | | | Tested | | |
| Viscosity (cP) | | 252500 | 150500 | 94500 | 64500 | 50000 | 50000 | 252500 | 226500 | 121000 | 418000 |
| (SP29, 16 g, | | | | | | | | | | | |
| 2 rpm) | | | | | | | | | | | |
| Sag (30 min/ | | | | | | | | | | | 2.9 |
| 73° F.) | | | | | | | | | | | |
| ASTM D2202 | | | | | | | | | | | |
| (inches) | | | | | | | | | | | |

TABLE 2
Moisture Scavenger

| | 0 weight % | 1.65 weight % | 3.3 weight % |
|---|---|---|---|
| Initial Viscosity (cP) | 1,516,000 | 516,000 | 122,000 |
| One Week (cP) | 1,600,000 | 610,000 | 232,000 |
| Two Weeks (cP) | 1,952,000 | 700,000 | 206,000 |
| Four Weeks (cP) | NT | 918,000 | 190,000 |
| 2 months (cP) | NT | NT | 198,000 |

Inventors found that a moisture scavenger can be helpful to maintain shelf stability in the sealant composition. In the above table, various amounts of p-toluenesulfonyl isocyanate (PTSI) available from OM Group was added to the sealant composition (Example 8) and the composition was aged according to the Shelf Stability Test Method.

Other embodiments are within the claims.

1. A sealant composition comprising:
a. from 3% by weight to 25% by weight of a thermoplastic elastomer,
b. from 1% by weight to 10% by weight of a silane modified polymer,
c. from 20% by weight to 50% by weight of a filler, and
d. from 20% by weight to 70% by weight of a solvent.

2. The sealant composition of claim 1, having a moisture content of no more than 1.0% by weight as tested by Karl Fischer titration according to ASTM D6304.

3. The sealant composition of claim 1, comprising a moisture scavenger.

4. The sealant composition of claim 1, being free of hazardous air pollutants as defined by the US Environmental Protection Agency.

5. The sealant composition of claim 1, wherein the thermoplastic elastomer is not silane modified.

6. The sealant composition of claim 1, wherein the thermoplastic elastomer is selected from the group consisting of butyl rubber, polychloroprene, polyisobutylene rubber, polybutene, ethylene vinyl acetate, ethylene alkyl acrylate, EPDM (ethylene-propylene-diene) rubber, block copolymer elastomers, styrenic block copolymer elastomers, functionalized versions thereof and combinations thereof.

7. The sealant composition of claim 1, wherein the silane modified polymer is selected from the group consisting of polyether, polyester, polyether/polyester block copolymers, polyurethane, polyacrylic, polyisobutylene, polyisoprene, polybutadiene and combinations thereof.

8. The sealant composition of claim 1, wherein the silane modified polymer is selected from the group consisting of polyethers, polyesters, polyether polyester copolymers, polyurethanes, and combinations thereof.

9. The sealant composition of claim 1, comprising from 1% by weight to 7% by weight of the silane modified polymer.

10. The sealant composition of claim 1, wherein the silane modified polymer is silane terminated with a tri-functional alpha silane.

11. The sealant composition of claim 1, wherein the filler is selected from the group consisting of calcium carbonate, precipitated calcium carbonate, clay, talc and a combination thereof.

12. The sealant composition of claim 1, wherein the solvent is selected from the group consisting of naphtha, mineral spirits, toluene, xylene, ethylbenzene, cumene, heptane, hexane, cyclohexane, pentane, ethyl acetate, methyl acetate, propyl acetate, acetone, parachlorobenzotrifluoride (PCBTF), methyl ethyl ketone (MEK), methyl isobutyl ketone, alcohols (e.g. isopropanol), propylene carbonate, dimethyl carbonate, tetrahydrofuran (THF) and combinations thereof.

13. The sealant composition of claim 1, wherein the solvent is selected from the group consisting of naphtha, heptane, mineral spirits and a combination thereof.

14. The sealant composition of claim 3, wherein the moisture scavenger is selected from the group consisting of p-toluenesulfonyl isocyanate (PTSI), vinyltrimethoxysilane (VTMO), vinyl triethoxysilane (VTEO), vinyltris(2-methoxyethoxy)silane (VTMOEO), molecular sieves, and combinations thereof.

15. The sealant composition of claim 1, further comprising a tackifying agent.

16. The sealant composition of claim 15, wherein the tackifying agent is a hydrocarbon resin selected from the group consisting of aliphatic, cycloaliphatic, aromatic, aliphatic-aromatic, aromatic modified alicyclic, and alicyclic hydrocarbon resins, modified versions and hydrogenated derivatives thereof, and combinations thereof.

17. The sealant composition of claim 1, having a viscosity at room temperature (RV7, 2 rpm) of from 100,000 cP to 600,000 cP.

18. The sealant composition of claim 1, wherein the sealant composition forms a skin in less than 15 minutes.

19. A sealant composition comprising:
a. from 3% by weight to 15% by weight of a thermoplastic elastomer selected from the group consisting of butyl rubber, polychloroprene, polyisobutylene rubber, polybutene, ethylene vinyl acetate, ethylene alkyl acrylate, EPDM (ethylene-propylene-diene) rubber, block copolymer elastomers, styrenic block copolymer elastomers, functionalized versions thereof and combinations thereof,
b. from 1% by weight to 7% by weight of a silane modified polymer,
c. from 25% by weight to 45% by weight of a filler,
d. from 3% by weight to 15% by weight of a tackifying agent,
e. from 25% by weight to 55% by weight of a solvent, and
f. a moisture scavenger.

20. A structure selected from the group consisting of a recreational vehicle, utility vehicle, trailer, bus, walk-in van, box truck, rail car, ambulance boat, and shed comprising the composition of claim 1.
